(19) United States
(12) Patent Application Publication
(10) Pub. No.: US 2013/0092054 A1
(43) Pub. Date: Apr. 18, 2013

(54) SOLID STATE COMBUSTION SYNTHESIS OF NANO TO MACROSCALE PORTLAND CEMENT AND OTHER HIGH VALUE NANO PARTICLES

(71) Applicant: Srinivas KILAMBI, Duluth, GA (US)

(72) Inventor: Srinivas KILAMBI, Duluth, GA (US)

(73) Assignee: SRIYA GREEN MATERIALS, INC., Duluth, GA (US)

(21) Appl. No.: 13/274,700

(22) Filed: Oct. 17, 2011

(51) Int. Cl. C04B 7/32; B01J 19/00; C04B 14/00; C04B 24/00; C04B 24/10

(52) U.S. Cl. 106/694; 106/692; 106/696; 106/695; 422/119

(57) ABSTRACT

A method of making Portland cement, white cement, calcium aluminates, calcium aluminum silicates and similar oxides using solid state combustion synthesis is described. The method uses less energy and produces lower CO₂ emissions than conventional processes. The method uses green fuels like biomass and lignin and eliminates most of the coal used in traditional cement production. A batch reactor and a semi-continuous reactor that can be used for the combustion synthesis are also described.

### BACKGROUND

1. Field

This invention relates generally to a method for making nano to macroscale powders of Portland cement, white cement, calcium aluminates, calcium aluminum silicates, etc. using solid state combustion synthesis, with fuels like biomass, lignin and coal at a lower cost, with lower CO₂ emissions and using smaller equipment.

2. Background of the Technology

Portland Cement is currently produced by heating a finely ground mixture of limestone, bauxite, clay and other minerals at temperatures around 1400° C.-1500° C. for around 20-30 min in a kiln. The final product is comprised of tri-calcium silicate (C₃S), di-calcium silicate (C₂S), tri-calcium aluminate (C₃A) and tetra-calcium aluminoferrite (C₄AF) in proportions as defined by ASTM. In general, the composition of Portland is as follows:

| CaO | SiO₂ | Al₂O₃ | Fe₂O₃ |
|---|---|---|---|
| 62~67 wt % | 20~24 wt % | 4~7 wt % | 3~5 wt % |

The product from a cement kiln consists of hot clinker which needs to be cooled, crushed and ground to a particle size varying from a few microns to ˜60 microns. Particle size and surface area play an important role in the hydration rate of cement. Commercially available Portland cement generally has a surface area ranging from 0.3 to 1.2 m²/g. Portland cement takes 7-14 days to set due to its micron-sized structure. This invention relates to the production of nano-sized cement particles, which will hydrate a lot faster and this offers a plethora of applications in building renovations, sealing and as an accelerating additive to presently used cements.

If cement is produced without the addition of iron oxide, the required reaction temperature over 1500° C. and the product formed is white cement, which is a high value product with specialized applications. The modern white cement production as a high value cement is an energy extensive process even higher than that of ordinary Portland cement. With the amount of emissions given out by the cement industry throughout the world, there brings a commitment for a change to reduce the consumption of energy and thereby reducing the emissions.

The technology presented aims at reducing the total energy consumed for production by supplying intrinsic exothermic sudden burst of energy which improves the heat transfer and mass transfer rates in order to counter the heavy heat losses faced by the modern day cement plants at the same time reducing the overall emissions.

The solid state combustion synthesis technique is a very important technique which could eventually replace the existing technique for cement production. Apart from the reduction of energy it produces superior nano particles which have higher reactivity and surface area which results in higher hydration rates. U.S. Patent Application Publication No. 2006/0097419 A1 describes the use of carbon sources to produce various oxides using solid state combustion synthesis.

The nano to macro powders of cement produced using these synthesis methods can effective control the hydration rates from a lower point thereby giving a wider range for the setting times and compressive strengths.

The solid phase interaction of the fuel with the oxygen media becomes the crust of the technology where carefully made molds of fuel and raw material mixture were heated in an oxygen rich environment. Once the fuel is ignited at about 90-150° C., it triggers an exothermic reaction which propagates in the form of a wave which transforms the raw mix into desired compositions of cement to produce white cement, calcium aluminates, calcium silicates and other oxide mixtures. The use of an in-organic fuel was the first ever tested at lab scale to be used as a combustion synthesis fuel. The several fuels tried but not limited to be Lignin, biomass and coal.

### SUMMARY

A method is provided which comprises:

combining a solid fuel with raw materials including calcium carbonate, an aluminum source, a silica source and optionally an iron source to form a mixture of the fuel and raw materials;

heating the mixture to the self-ignition temperature of the fuel such that the fuel combusts;

allowing the heat generated by the combustion of the fuel to react the raw materials in the mixture to form reaction products including tri-calcium silicate, di-calcium silicate, tri-calcium aluminate and tetra-calcium aluminoferrite; and

cooling the reaction products.

Particles of cementitious material made by the method described above are also provided.

A reactor is also provided which comprises:

a) a reaction chamber;

b) a heater adapted to heat the reaction chamber;

c) a gas inlet for oxygen supply;

d) one or more thermocouples adapted to measure the temperature inside the reaction chamber; and

e) one or more side windows adapted to maintain the pressure inside the reaction chamber.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1. is a schematic of a batch reactor for the solid-state combustion synthesis of nano cement and other oxides.

FIG. 2. is a schematic of a kiln type batch reactor to produce larger batches of cement using solid-state combustion synthesis.

FIG. 3 is a schematic of a continuous expanded reactor to produce larger quantities of cement using solid-state combustion synthesis

### DESCRIPTION OF THE VARIOUS EMBODIMENTS

Disclosed are methods to produce nano to macro sized ordinary Portland cement (OPC), calcium aluminate cements (CAC), white cements and calcium aluminum silicate (CAS) cements using different economical fuels such as pure biomass, pure lignin and coal combinations. The described methods provide an environmentally friendly route to produce nano to macro sized silicates, oxides or aluminates using renewable fuels such as biomass, lignin and their combinations.

As described herein, fuels such as biomass, lignin and/or a combination fuel mixture of biomass-coal or lignin-coal or biomass-lignin-coal can be used to produce a highly exothermic chemical reaction between the fuel and the reactants to produce multiple silicates, oxides and aluminates using the solid combustion synthesis platform.

In a conventional cement manufacturing process, the solid mixture has to be heated to 1450° C. so that it can be partially melted and the solid liquid reaction can be faster than solid reaction. The whole process can take more than 30 minutes. In solid combustion, the raw materials are homogeneously mixed and are ignited in a reaction medium in the presence of air/oxygen (if not supplied internally). Ignition on the sample can be done on one face of the sample or on the entire volume. Once the fuel ignites, it does not require any external heating to sustain the reaction further. This result in substantial process energy savings compared to the conventional process. Also the reaction goes to completion in less than a minute compared to the conventional calcination process which last for approximately 30 minutes.

In one method to produce ordinary Portland cement (OPC), nitrate salts such as calcium nitrate, aluminum nitrates, iron nitrates (sources of calcium, aluminum and iron) with silica as raw materials combined with a fuel such as biomass, lignin and their combinations with coal. The combination of the metal precursors with the solid fuels is brought together in a reaction mixture and is ignited in the presence of minimal oxygen/air to trigger the combustion reaction. Once ignited the combustion wave within the reaction sample with generate an intensive exothermic reaction which will sustain itself long enough to complete the synthesis. The average residence times for the entire combustion process lasts for less than al minute (e.g., 30-40 secs.). In this case the resulting product contains the same components as conventional portland cement, including tri-calcium silicate, di-calcium silicate, tri-calcium aluminate and tetra-calcium aluminoferrite.

In another instance, a method involving usage of the same raw materials as those used in conventional cement industries (e.g., limestone, clay, sand and iron ore) with fuels such as biomass, lignin and coal mixtures was used. In this method the lack of oxygen (given off from nitrates) in the process is supplied externally to sustain the combustion reaction to completion. After ignition at low temperatures (e.g., ˜100° C.-150° C.) the combustion reaction continues to completion with the maximum temperatures recorded externally as ˜1350° C. The different fuels like biomass, lignin and their combinations can be used in the process in fuel compositions from 5-40% based on their calorific heat contents. Also externally supplied oxygen flow rates can be varied between 0-15 L/min depending on the fuel content

According to some embodiments solid combustion synthesis is used to produce nano particles with superior reactivity and higher reaction as well as hydration rates.

Nano to macro particles were prepared by solid combustion synthesis by using the following steps:
1) The raw materials were prepared based on the final composition required like alumina rich for calcium aluminates, silica rich for calcium silicates and Iron deficient for white cement.
2) The resulting raw mix was homogenously mixed/ground with the raw mix.
3) In case of limestone the fuel was crushed with the raw material. While performing lab scale experiments where carbonates or nitrates were used the fuel was mixed with the raw mix prepared as a mixture of aluminum oxide, iron oxide, limestone and silica based on the final composition required.
4) The fuel was based on various scales of optimization involved a range from 5%-60% the overall raw mix weight.
5) Different fuel mixtures were tried based on the calorific value.
6) Most commonly used was a mixture of lignin and Biomass, other compositions used were biomass-coal, lignin-coal and biomass-lignin-coal.
7) Once the raw material was mixed with the fuel ⅕^{th} part by weight of water was added as a binding solvent.
8) The fuel raw material mixture was then placed in 2×2 inch molds and dried in an oven overnight at 55° C.
9) The dried molds were then placed in a reaction chamber with continuous oxygen supply and ignited at 90-150° C. using heating elements.
10) The clinker was then subsequently cooled once the redox reaction sufficed.

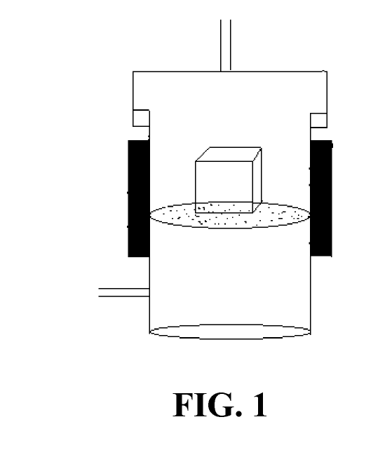

5-50 g/batch molds were made using a simple experimental setup as shown in FIG. 1 which consisted mainly of a combustion chamber, heating elements, perforated stainless steel plates for O₂ supply and outlet for gasses. The conventional method of manufacturing, transfers heat of the fuel from a flame and heats up the raw material mixture which gives out extrinsic heat and this process requires additional heat owing to the heat losses from mass and heat transfer. The solid combustion synthesis technique supplies intrinsic heat as the raw mix in itself acts as a fuel. The raw mix composition along with the intrinsic supply of oxygen and fuel forms the reaction mixture which creates an exothermic mixture at the surface of the reactants thereby inducing efficient mass and transfer rates and this in turn generates tremendous amount of heat in a short span of time creating a violent medium for combustion and nano particle formation. The nano particles formed have superior surface area and hydration rates thereby improving the compressive strength. Some of the uses involve binding with the cement mixtures thereby increasing its physical properties.

The following reactions give a detailed description of the actual kinetic mechanism.

### Ordinary Portland Cement (OPC)

CaCO₃→CaO+CO₂ (1)

2CaO+SiO₂→2CaO.SiO₂ (2)

2CaO.SiO2+CaO→3CaO.SiO₂ (3)

3CaO+Al₂O₃→3CaO.Al2O₃ (4)

4CaO+Al₂O₃+Fe₂O₃→4CaO.Al₂O₃.Fe₂O₃ (5)

### Aluminum Cements

CaCO₃→CaO+CO₂ (6)

X1 CaO+(Y1) Al₂O₃→XCaO.YAl₂O₃ (7)

(X2-X1) CaO+USiO₂→XCaO.USiO₂ (8)

(X3-X2-X1) CaO+(Y2-Y1) Al₂O₃+Z Fe₂O₃→XCaO.YAl₂O₃.ZFe₂O₃ (9)

X,Y,Z and U defines the number of moles of calcium oxide, aluminum oxide, iron oxide and silicon di-oxide required based on the final product or different grades of calcium aluminates produces.

The different grades of calcium aluminates and the compositions of the different oxides have been listed in Table 1 below.

TABLE 1
TYPE

| Properties | TYPE 1 | TYPE 2 | TYPE 3 |
|---|---|---|---|
| Al₂O₃ | 37-42 | 49-52 | 68-80 |
| CaO | 36-4 | 39-42 | 17-2 |
| Fe₂O₃ | 11-17 | 1-5 | 0-0.5 |
| SiO₂ | 3-8 | 5-8 | 0-0.5 |

### White Cement

CaCO₃→CaO+CO₂ (10)

2CaO+SiO₂→2CaO.SiO₂ (11)

2CaO.SiO₂+CaO→3CaO.SiO₂ (12)

3CaO+Al₂O₃→3CaO.Al₂O₃ (13)

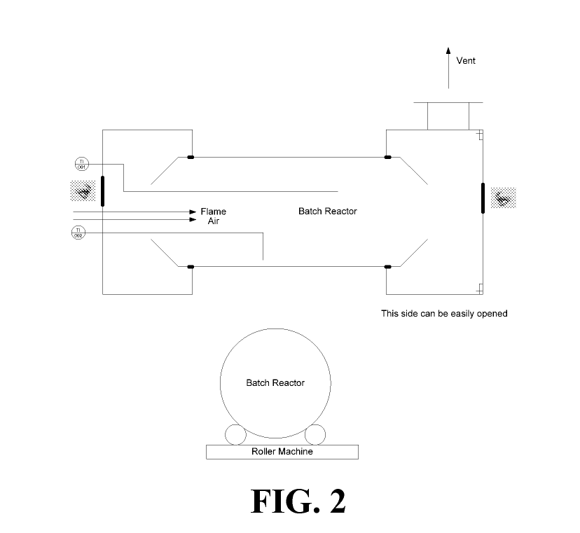

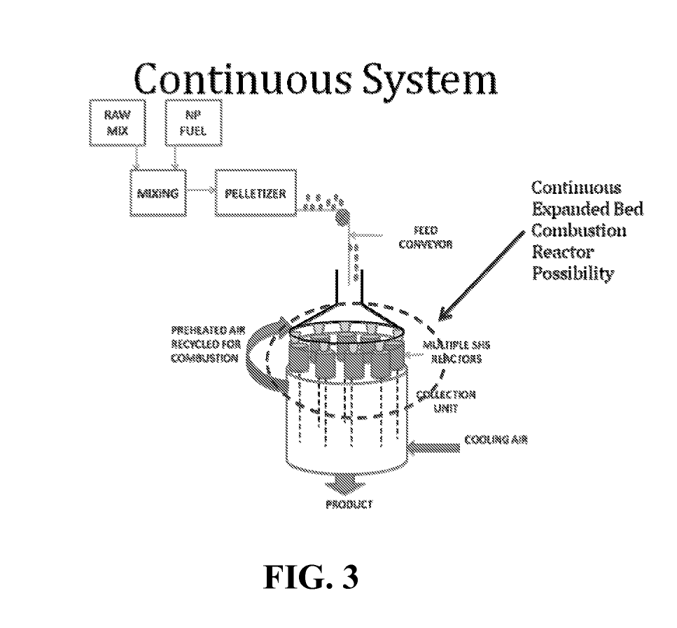

In another embodiment, a kiln-type rotary batch reactor (FIG. 2) and a continuous expanded bed combustion reactor (FIG. 3), fired with natural gas was used to produce the different cements. In this system, batches of 1-2 kg of cement was produced. Experiments were performed with both compacted and non-compacted raw mix. Some of the details on this reactor are:
Inner wall lined with refractor material;
L/D ratio: 2;
Capacity: 3 kg of cement;
Air Inlet/Flue gases out let;
Maximum operating temperature: 1650° C.; and
Carbon steel/Stainless Steel outer jacket.
   The science of combustion synthesis depends on the fuel to oxidizer ratio which is controlled by the amount of residual oxygen present or passed through the molds per unit volume of the fuel. This based on the fuel composition in turn based on the raw mix composition triggers the reduction oxidation reaction which leads to an exothermic energy.

The above mechanism was followed with different fuels and fuel mixtures with different compositions of fuel to raw material ratio and different oxidizer ratio to get to an optimum number for fuel and oxidizer. The listed procedure along with different compositions have been discusses in detail in the following examples.

### EXPERIMENTAL

The practice of this invention can be further understood by reference to the following examples, which are provided by way of illustration only are not intended to be limiting.

### EXAMPLE 1

### Optimization of Fuel to Cement Ratio for Solid Combustion Synthesis

Experiments were conducted for different compositions of finished product based on the fuel percentage of the total raw mix weight. A set of experiments were conducted following the steps described above to find out the exact fuel to cement ratio based on the results.

| | Fuel/cement | | Free lime | Insoluble |
|---|---|---|---|---|
| Sample No. | (%) | LOI (%) | (%) | Residue (%) |
| 1 | 40 | 2.0 | 10 | 1.1 |
| 2 | 50 | 1.7 | 6 | 1.7 |
| 3 | 60 | 0.5 | 3 | 1.5 |

As seen in the table the optimized ratio was found out to be 60%. The fuel used here was biomass.

### EXAMPLE 2

### Use of Different Fuel Mixtures Used and Optimization

Based on the above results and the calorific value of biomass the total energy required was calculated and a series of experiments were conducted based on different fuel mixtures. The 4 fuel mixtures used were lignin-biomass, biomass-coal biomass-coal-lignin and lignin-coal. The above steps were followed for the mold preparation and drying. The dried molds were then placed in heating chambers and ignited. The ignited molds were then cooled and the cement was tested. The following results were tabulated and the lignin-biomass combinations yielded superior results.

| | | | Free Lime | Insoluble |
|---|---|---|---|---|
| Sample No. | Fuel | LOI (%) | (%) | Residue (%) |
| 4 | Biomass | 0.5 | 3 | 1.5 |
| 5 | Lignin | 0.3 | 1.2 | 1.1 |
| 6 | Biomass-coal | 0.3 | 0.9 | 0.8 |
| 7 | Lignin-coal | 0.35 | 0.85 | 0.9 |
| 8 | Lignin-biomass | 0.2 | 0.6 | 0.1 |

### EXAMPLE 3

### Use of Solid Combustion Synthesis to Synthesize OPC Using Nitrates and Pure Biomass

Ordinary Portland cement (OPC) was synthesized from a reactant mixture comprising (in % by mass): calcium nitrate trihydrate(Ca(NO₃)₂.3H₂O) 49.48, silica (SiO₂) 4.65, aluminum nitrate(Al(NO₃)3.9H₂O) 4.65,ferric nitrate (Fe(NO₃)₃) 1.20 and pure biomass 40.02. The mixture of the nitrates and the fuel were homogenized mechanically and compacted into cubes, granules or pellets or used as loose powder for solid combustion synthesis. The reaction mixture was placed in an alumina crucible and ignited in a lab scale oven maintained at 500° C. Following ignition at ˜120° C., combustion wave propagation takes the maximum temperature to ˜1200° C.

| Sample No. | LOI | Free Lime | Insoluble Residue |
|---|---|---|---|
| 9 | 0.6 | 2.0 | 1.2 |
| 10 | 0.7 | 1.8 | 1.7 |
| 11 | 0.5 | 2.2 | 1.5 |

### EXAMPLE 4

### Use of Solid Combustion Synthesis to Synthesize OPC Using Nitrates and Pure Lignin

Ordinary Portland cement (OPC) was synthesized from a reactant mixture comprising (in % by mass): calcium nitrate trihydrate(Ca(NO₃)₂.3H₂O) 49.48, silica (SiO2) 4.65, aluminum nitrate(Al(NO₃)3.9H₂O) 4.65,ferric nitrate (Fe(NO₃)₃) 1.20 and pure lignin 40.02. The mixture of the nitrates and the fuel were homogenized mechanically and compacted into cubes or used as loose powder for solid combustion synthesis. The reaction mixture was placed in an alumina crucible and ignited in a lab scale oven maintained at 500° C. Following ignition at ˜160° C., combustion wave propagation takes the maximum temperature to ˜1350° C.

| Sample No. | LOI | Free Lime | Insoluble Residue |
|---|---|---|---|
| 12 | 0.8 | 1.8 | 0.6 |
| 13 | 0.9 | 1.6 | 0.7 |
| 14 | 1.2 | 1.9 | 0.9 |

### EXAMPLE 5

### Use of Solid Combustion Synthesis to Synthesize OPC Using Nitrates and Biomass/Lignin-Coal Combinations

Ordinary Portland cement (OPC) was synthesized from a reactant mixture comprising (in % by mass): calcium nitrate trihydrate(Ca(NO₃)₂.3H₂O) 49.48, silica (SiO₂) 4.65, aluminum nitrate(Al(NO₃)₃.9H₂O) 4.65,ferric nitrate (Fe(NO₃)₃) 1.20 and a combination of coal 20 and biomass (or lignin) 20. The mixture of the nitrates and the fuel were homogenized mechanically and compacted into cubes or used as loose powder for solid combustion synthesis. The reaction mixture was placed in an alumina crucible and ignited in a lab scale oven maintained at 500° C. Following ignition at ˜160° C., combustion wave propagation takes the maximum temperature to ˜1350° C.

| Sample No. | LOI | Free Lime | Insoluble Residue |
|---|---|---|---|
| 15 | 0.6 | 0.9 | 0.9 |
| 16 | 0.8 | 1.3 | 0.7 |
| 17 | 0.9 | 1.4 | 0.85 |

### EXAMPLE 6

### Use of Solid Combustion Synthesis to Synthesize OPC Using Carbonates and Pure Biomass

Ordinary Portland cement (OPC) was synthesized from a reactant mixture comprising (in % by mass): calcium carbonate (CaCO3) 46.8, silica (SiO₂) 9.4, aluminum oxide (Al₂O₃) 1.27,ferric oxide (Fe₂O₃) 2.47 and pure biomass 40. The mixture of the carbonates/oxides and the fuel (biomass) were homogenized mechanically and compacted into cubes or used as loose powder for solid combustion synthesis. The reaction mixture was placed in an alumina crucible and ignited in a lab scale oven maintained at 500° C. Following ignition at ˜120° C., combustion wave propagation takes the maximum temperature to ˜1200° C.

| Sample No. | LOI | Free Lime | Insoluble Residue |
|---|---|---|---|
| 18 | 0.4 | 3.3 | 0.2 |
| 19 | 0.3 | 2.2 | 0.5 |
| 20 | 0.2 | 2.3 | 0.7 |

### EXAMPLE 7

### Use of Solid Combustion Synthesis to Synthesize OPC Using Carbonates and Pure Lignin

Ordinary Portland cement (OPC) was synthesized from a reactant mixture comprising (in % by mass): calcium carbonate (CaCO₃) 46.8, silica (SiO₂) 9.4, aluminum oxide (Al₂O₃) 1.27, ferric oxide (Fe₂O₃) 2.47 and pure lignin 40. The mixture of the carbonates/oxides and the fuel (lignin) a homogenized mechanically and compacted into cubes or used as loose powder for solid combustion synthesis. The reaction mixture was placed in an alumina crucible and ignited in a lab scale oven maintained at 500° C. Following ignition at ˜160° C., combustion wave propagation takes the maximum temperature to ˜1350° C.

| Sample No. | LOI | Free Lime | Insoluble Residue |
|---|---|---|---|
| 21 | 0.3 | 2.3 | 0.8 |
| 22 | 0.2 | 1.5 | 0.7 |
| 23 | 0.5 | 1.8 | 0.85 |

### EXAMPLE 8

### Use of Solid Combustion Synthesis to Synthesize OPC Using Carbonates and Biomass/Lignin-Coal Combinations

Ordinary Portland cement (OPC) was synthesized from a reactant mixture comprising (in % by mass): calcium carbonate (CaCO₃) 46.8, silica (SiO₂) 9.4, aluminum oxide (Al₂O₃) 1.27, ferric oxide (Fe₂O₃) 2.47 and combination fuel of coal 20 and biomass (or lignin) 20. The mixture of the carbonates/oxides and the fuel (lignin) a homogenized mechanically and compacted into cubes or used as loose powder for solid combustion synthesis. The reaction mixture was placed in an alumina crucible and ignited in a lab scale oven maintained at 500° C. Following ignition at ˜160° C., combustion wave propagation takes the maximum temperature to ˜1350° C.

| Sample No. | LOI | Free Lime | Insoluble Residue |
|---|---|---|---|
| 24 | 0.2 | 0.4 | 0.1 |
| 25 | 0.1 | 0.8 | 0.6 |
| 26 | 0 | 0.4 | 0.5 |

### EXAMPLE 9

### Use of Solid Combustion Synthesis to Synthesize Calcium Aluminate Cements

Calcium Aluminate cement (CAC) was synthesized from a reactant mixture comprising (in % by mass): calcium carbonate (CaCO₃) 29.86, silica (SiO₂) 2.50, aluminum oxide (Al₂O₃) 21.32, ferric oxide (Fe₂O₃) 6.315 and fuel (pure biomass or pure lignin or combination of biomass/lignin and coal) 39.9. The mixture of the carbonates/oxides and the fuel a homogenized mechanically and compacted into cubes or used as loose powder for solid combustion synthesis. The reaction mixture was placed in an alumina crucible and ignited in a lab scale oven maintained at 500C. Following ignition at ˜100° C. to 160° C. (based on fuel used), combustion wave propagation takes the maximum temperature to ˜1100° C. to 1300° C.

| Sample No. | LOI | Free Lime | Insoluble Residue |
|---|---|---|---|
| 25 | 0.1 | 0.1 | 0.3 |
| 26 | 0.3 | 0.5 | 0.9 |
| 27 | 0.4 | 0.3 | 0.85 |

### EXAMPLE 10

### Use of Solid Combustion Synthesis to Synthesize White Cement

White cement (CAC) was synthesized from a reactant mixture comprising (in % by mass): calcium carbonate (CaCO₃) 48.83, silica (SiO₂) 9.830, aluminum oxide (Al₂O₃) 1.33 and fuel (pure biomass or pure lignin or combination of biomass/lignin and coal) 39.92. The mixture of the carbonates/oxides and the fuel a homogenized mechanically and compacted into cubes or used as loose powder for solid combustion synthesis. The reaction mixture was placed in an alumina crucible and ignited in a lab scale oven maintained at 500° C. Following ignition at ˜100° C. to 160° C. (based on fuel used), combustion wave propagation takes the maximum temperature to ˜1100° C.-1300° C.

| Sample No. | LOI | Free Lime | Insoluble Residue |
|---|---|---|---|
| 26 | 0.5 | 2.1 | 1.3 |
| 27 | 0.7 | 0.9 | 1.8 |
| 28 | 0.9 | 1.3 | 0.95 |

### EXAMPLE 11

### Use of Solid Combustion Synthesis to Synthesize Calcium Aluminate Silicates Cements

Calcium aluminate silicates (CAS) was synthesized from a reactant mixture comprising (in % by mass): calcium nitrate trihydrate(Ca(NO₃)₂.3H₂O) 43.5, silica (SiO₂) 7.3, aluminum nitrate(Al(NO₃)₃.9H₂O) 6.72,ferric nitrate (Fe(NO₃)₃) 2.4 and fuel (pure biomass or pure lignin or combination of biomass/lignin and coal) 40. The mixture of the nitrates and the fuel were homogenized mechanically and compacted into cubes or used as loose powder for solid combustion synthesis. The reaction mixture was placed in an alumina crucible and ignited in a lab scale oven maintained at 500° C. Following ignition at ˜120° C., combustion wave propagation takes the maximum temperature to ˜1000° C.-1100° C.

| Sample No. | LOI | Free Lime | Insoluble Residue |
|---|---|---|---|
| 29 | 0 | 0.1 | 0.5 |
| 30 | 0.45 | 0.8 | 0.9 |
| 31 | 0.3 | 0.8 | 1.2 |

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A method comprising:
combining a solid fuel with raw materials including calcium carbonate, an aluminum source, a silica source and optionally an iron source to form a mixture of the fuel and raw materials;
heating the mixture to the self-ignition temperature of the fuel such that the fuel combusts;
allowing the heat generated by the combustion of the fuel to react the raw materials in the mixture to form reaction products including tri-calcium silicate, di-calcium silicate, tri-calcium aluminate and tetra-calcium aluminoferrite; and
cooling the reaction products.

2. The method of claim 1, wherein the calcium carbonate is limestone.

3. The method of claim 1, wherein the aluminum source comprises aluminum oxide, aluminum nitrate or aluminum acetate.

4. The method of claim 1, wherein the iron source comprises iron nitrate or iron oxide.

5. The method of claim 1, wherein the fuel is a fuel selected from the group consisting of lignin, biomass, coal and combinations thereof.

6. The method of claim 1 wherein the silica source and the aluminum source each comprise clay.

7. The method of claim 1, wherein the raw materials comprise a Portland cement raw material mixture.

8. The method of claim 1, wherein the raw materials are a pre-calciner and or pre-kiln feed for Portland cement manufacture and wherein the method further comprises adding nitric acid to the mixture.

9. The method of claim 1, further comprising forming the mixture and drying the formed mixture before heating the mixture to the self-ignition temperature of the fuel.

10. The method of claim 1, wherein the solid fuel comprises a mixture of fuels.

11. The method of claim 1, wherein the mixture is formed by molding, granulating or pelletizing.

12. Particles of cementitious material produced according to the method of claim 1.

13. A reactor comprising:
a) a reaction chamber;
b) a heater adapted to heat the reaction chamber;
c) a gas inlet for oxygen supply;
d) one or more thermocouples adapted to measure the temperature inside the reaction chamber; and
e) one or more side windows adapted to maintain the pressure inside the reaction chamber.

14. The reactor of claim 13, wherein the reaction chamber is adapted to rotate.

15. The method of claim 1, wherein the silica source is fumed silica or colloidal silica.

16. The method of claim 9, further comprising adding a binding material to the mixture before forming.

17. The method of claim 16, wherein the binding material comprises a solvent, ethanol, benzene or water.

18. The method of claim 1, wherein the reaction products comprise 62-67 weight percent CaO, 20-24 weight percent SiO₂, 4-7 weight percent Al₂O₃, and 3-5 weight percent Fe₂O₃.

19. The method of claim 1, wherein the reaction products comprise at least 35 weight percent Al₂O₃.

20. The method of claim 1, wherein the mixture is in a solid form prior to heating.
